(19) United States
(12) Patent Application Publication
(10) Pub. No.: US 2005/0253320 A1
(43) Pub. Date: Nov. 17, 2005

(54) Multi-layer chopping board

(76) Inventor: Shu-Hui Chang, Taichung County (TW)

Correspondence Address: BACON & THOMAS, PLLC, 625 SLATERS LANE, FOURTH FLOOR, ALEXANDRIA, VA, 22314, US

(21) Appl. No.: 10/844,505

(22) Filed: May 13, 2004

(51) Int. Cl. B23Q 3/00

(52) U.S. Cl. 269/289 R

(57) ABSTRACT

A multi-layer chopping board includes a main body having a plurality of regular planks and a reinforced plank stacked upon another, and a cover layer sheathed on a peripheral side of the main body to couple the planks. The reinforced plank is made of a material more inflexible than that of each regular plank. The cover layer is made of a material different from that of any of the planks.

### BACKGROUND OF THE INVENTION

1. Field of the Invention

The present invention relates generally to kitchenware, and more particularly to a multi-layer chopping board.

2. Description of the Related Art

A conventional plastic multi-layer chopping board is comprised of numerous stacked planks which peripheral edges are jointed one by one by heat-fusing method. If the top plank is damaged, the top plank can be peeled off by cutting out the joint between the top plank and the secondary plank positioned below the top plank by a knife, such that the secondary plank is exposed outside for use. The multi-layer chopping board, therefore, can be used for a long time.

To prevent the planks from damage that may be caused by constant cutting of the chopping knives, the planks of the multi-layer chopping board are made of hard plastic materials, however making it difficult to cut out the joint between each two adjacent planks to split the two planks. Further, while the user cuts out the joint, the chopping knife may be subject to slipping off the joint to hurt the user's hands.

In addition, as several planks are gradually peeled off the conventional multi-layer chopping board, the thickness of the whole chopping board gets smaller and smaller to cause lower and lower rigidity. In the meantime, when the chopping board is used, the board is subject to deformation by the cutting of the chopping knife to probably form concavity on its top side, such that the knife fails to effectively cut on the chopping board to further cause inconvenience.

### SUMMARY OF THE INVENTION

The primary objective of the present invention is to provide a multi-layer chopping board, which is preferably inflexible.

The secondary objective of the present invention is to provide a multi-layer chopping board, which planks can be easily cut out and split.

The foregoing objectives of the present invention are attained by the multi-layer chopping board, which is comprised of a main body having a plurality of regular planks and a reinforced plank stacked upon another, and a cover layer sheathed on a peripheral side of the main body to couple the planks. The reinforced plank is made of a material more inflexible than that of each regular plank. The cover layer is made of a material different from that of any of the planks.

### BRIEF DESCRIPTION OF THE DRAWINGS

FIG. 1 is a perspective view of a first preferred embodiment of the present invention;

FIG. 2 is a sectional view taken along a line 2-2 indicated in FIG. 1;

FIG. 3 is another sectional view of the first preferred embodiment of the present invention;

FIG. 4 is a perspective view of a second preferred embodiment of the present invention;

FIG. 5 is a sectional view taken along a line 5-5 indicated in FIG. 4;

FIG. 6 is a perspective view of the second preferred embodiment of the present invention, showing a top regular plank is being peeled therefrom;

FIG. 7 is a perspective view of a third preferred embodiment of the present invention;

FIG. 8 is a perspective view of a fourth preferred embodiment of the present invention;

FIG. 9 is a perspective view of a fifth preferred embodiment of the present invention;

FIG. 10 is a sectional view taken along a line 10-10 indicated in FIG. 8;

FIG. 11 is a perspective view of a sixth preferred embodiment of the present invention;

FIG. 12 is a sectional view of a seventh preferred embodiment of the present invention;

FIG. 13 is a sectional view of an eighth preferred embodiment of the present invention, and

FIG. 14 is a sectional view of a ninth preferred embodiment of the present invention.

### DETAILED DESCRIPTION OF THE INVENTION

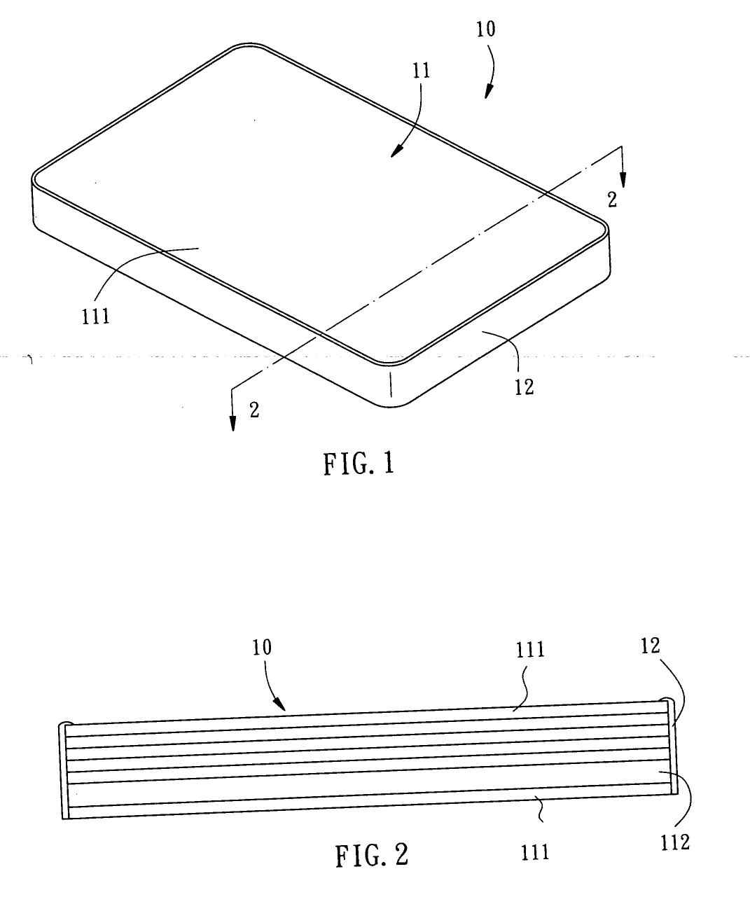

Referring to FIGS. 1 and 2, a multi-layer chopping board 10 constructed according to a first preferred embodiment of the present invention is comprised of a main body 11 and a cover layer 12.

The main body 11 includes a plurality of regular planks 111, which are made of food-grade polyethylene (PE) or other alternative rigid plastic materials, and a reinforced plank 112, which is made of a wood laminate. The regular planks 111 and the reinforced plank 112 are stacked upon another. The reinforced plank 112 is located between the bottom first and second regular planks 111 or between the bottom second and third regular planks 111, and can be made of a material more inflexible than that of each regular plank 111, like solid wood, acrylics, or metallic material.

The cover layer 12 is made of rubber plus PE, thermoplastic rubber (TPR), or other alternative material that is softer than that of the main body 11. The cover layer 12 is sheathed on a peripheral side of the main body 11 to put together the planks 111 and 112 by injection molding of second time or other alternative process to further prevent the planks 111 and 112 disposed therein from erosion or damage incurred by dampness or contamination under external exposure.

The reinforced plank 112 is preferably inflexible to further enhance the inflexibility of the main body 11. When the chopping board 10 fails to be smoothly placed on a plane surface of a worktable, the main body 11 can counteract against downward pressure incurred by a chopping knife to avoid downward deformation. In addition, the cover layer 12 is softer than the regular planks 111 to be easily cut through by a knife at where between each two adjacent regular planks 111 to further successfully split the two regular planks 111.

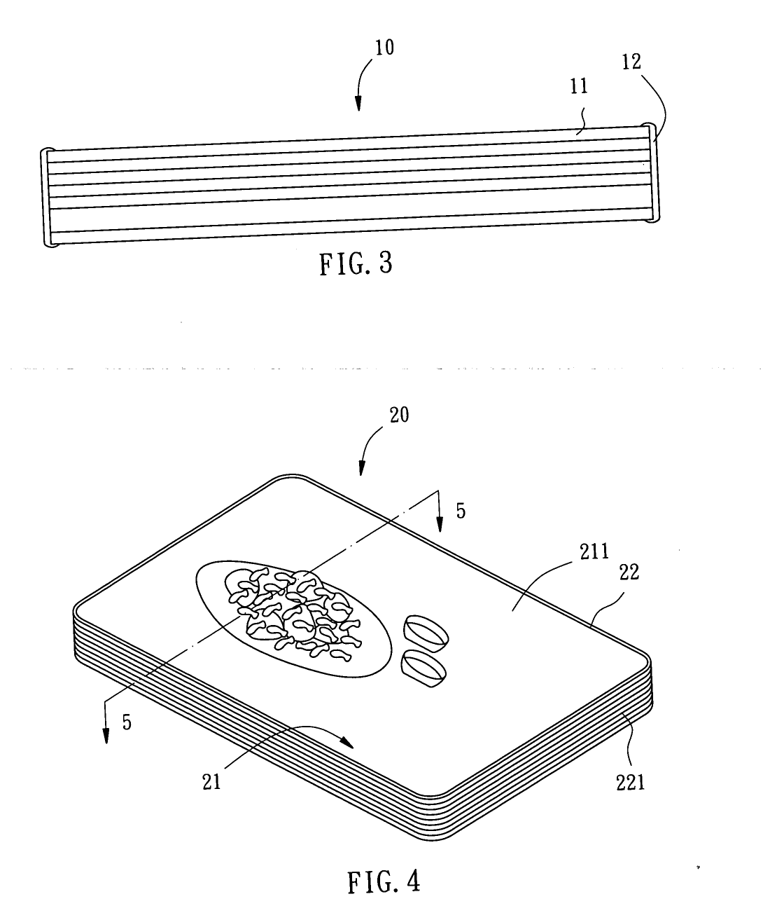

Referring to FIG. 3, the cover layer 12 can be further sheathed on, in addition to the peripheral side, peripheral edges of a top side and a bottom side of the main body 11. Accordingly, when the chopping board 10 is put on the worktable for use, the cover layer 12 formed at the peripheral edge of the top side of the main body 11 can prevent food fluid from overspill that may stain the worktable. In addition, the cover layer 12 formed at the peripheral edge of the bottom side of the main body 11 frictionally contacts against the worktable such that the chopping board 10 has a greater friction against the worktable to be skidproof and to avoid its slipperiness with respect to the worktable.

Referring to FIGS. 4-6, the multi-layer chopping board 20 constructed according to a second preferred embodiment of the present invention is similar to the chopping board 10 of the first preferred embodiment but different as recited below.

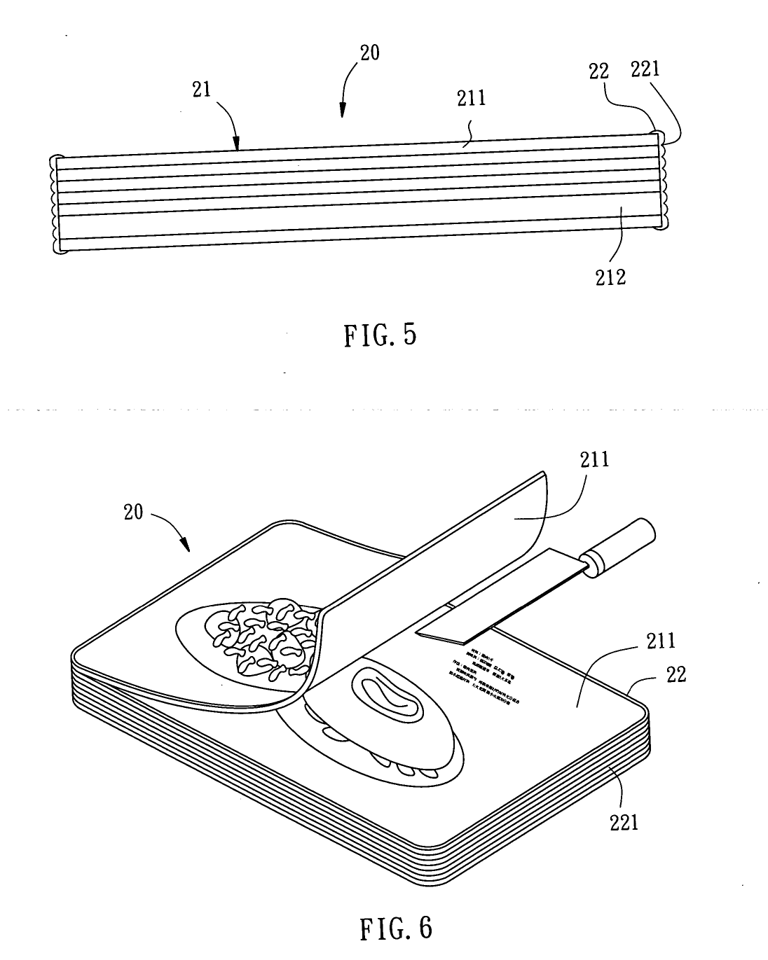

The cover layer 22 sheathed on the peripheral side of the main body 21 is provided with a plurality of guiding portions 221, each of which is an endless groove continuously recessed on the cover layer 22 at corresponding position to where between each two adjacent regular planks 211, as shown in FIGS. 4 and 5. If the plank 211 needs to be peeled from the chopping board 20, the user can put a knife at the guiding portion 221 of the cover layer 22 and stab the knife through the cover layer 22 and then into where between each adjacent two regular planks 211 to successfully cut off the planks 211.

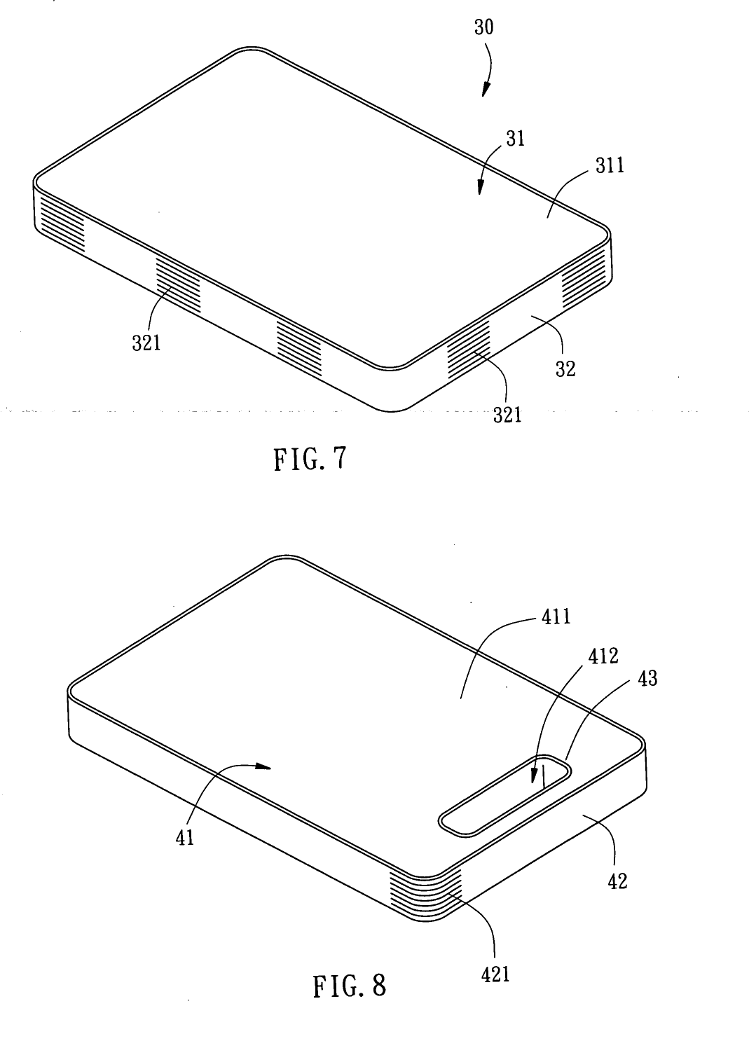

Referring to FIG. 7, the multi-layer chopping board 30 constructed according to a third preferred embodiment of the present invention is similar to the chopping board 30 of the second preferred embodiment, but different only by that the guiding portions 321 are discontinuously formed on the peripheral side of the cover layer 32.

Referring to FIG. 8, the multi-layer chopping board 40 constructed according to a fourth preferred embodiment of the present invention is similar to the chopping board 30 of the second preferred embodiment, but different as recited below.

Each of the regular planks 411 and the reinforced plank (not shown) is provided with an opening, which is formed at the same location thereof and vertically aligned with the others, such that the openings together define a slot 412 running through the main body 41. Further, a cover layer 43 is also sheathed on a sidewall of the slot 412 for preventing the planks 111 and 112 from erosion or damage incurred by dampness or contamination under external exposure. The slot 412 facilitates the user's holding the chopping board 40.

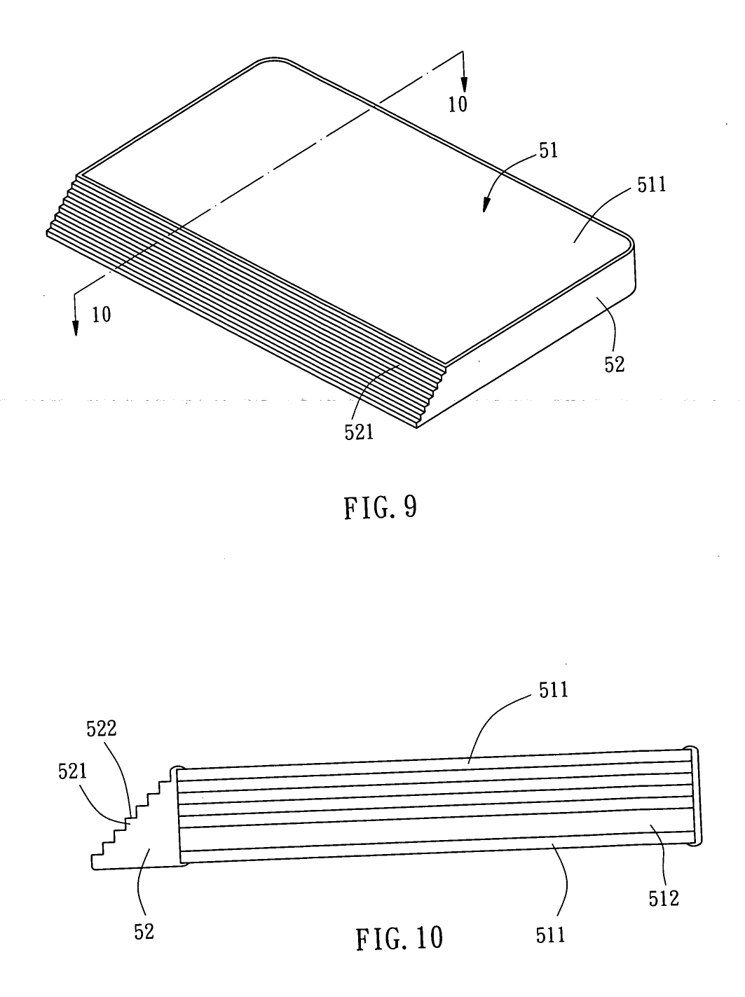

Referring to FIGS. 9 and 10, the multi-layer chopping board 50 constructed according to a fifth preferred embodiment of the present invention similar to the chopping board 10 of the first preferred embodiment, but different as recited below.

The cover layer 52 includes a plurality of stepped portions 521 formed at a lateral side thereof. Each of the stepped portions 521 has a horizontal side 522 corresponding to where between each two adjacent planks 511 to define a guiding portion. While peeling off the planks 511, put a knife to lie on the horizontal side 522 and stab the knife along the horizontal side 522 and through where between each two adjacent planks 511 to further cut off the planks 511.

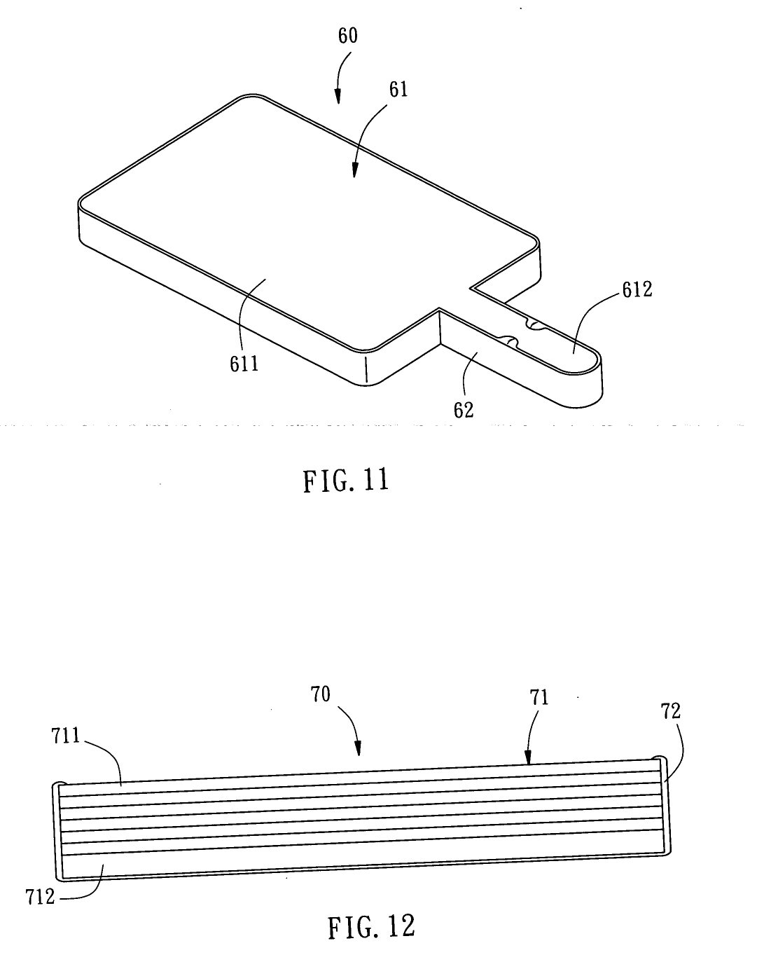

Referring to FIG. 11, the chopping board 60 constructed according to a sixth preferred embodiment of the present invention is similar to the chopping board 10 of the first preferred embodiment, but different as recited below.

The chopping board 60 has a handle 612 extending outwards from a lateral side of the main body 61 for enhancing holding comfortableness and for being skidproof. The handle 612 is also provided with the regular planks 611 and the reinforced plank (not shown) and sheathed with the cover layer 62 at a peripheral side thereof and a peripheral edge of a top side thereof. In addition, the cover layer 62 located on the peripheral edge of the top side of the handle 612 can be formed with a predetermined design for aesthetic appearance.

Referring to FIG. 12, the chopping board 70 constructed according to a seventh preferred embodiment of the present invention is similar to the chopping board 10 of the first preferred embodiment, but different as recited below.

The reinforced plank 712 is located at the bottom side of the main body 71. The cover layer 72 is sheathed on, in addition to the peripheral side, the bottom side of main body 71.

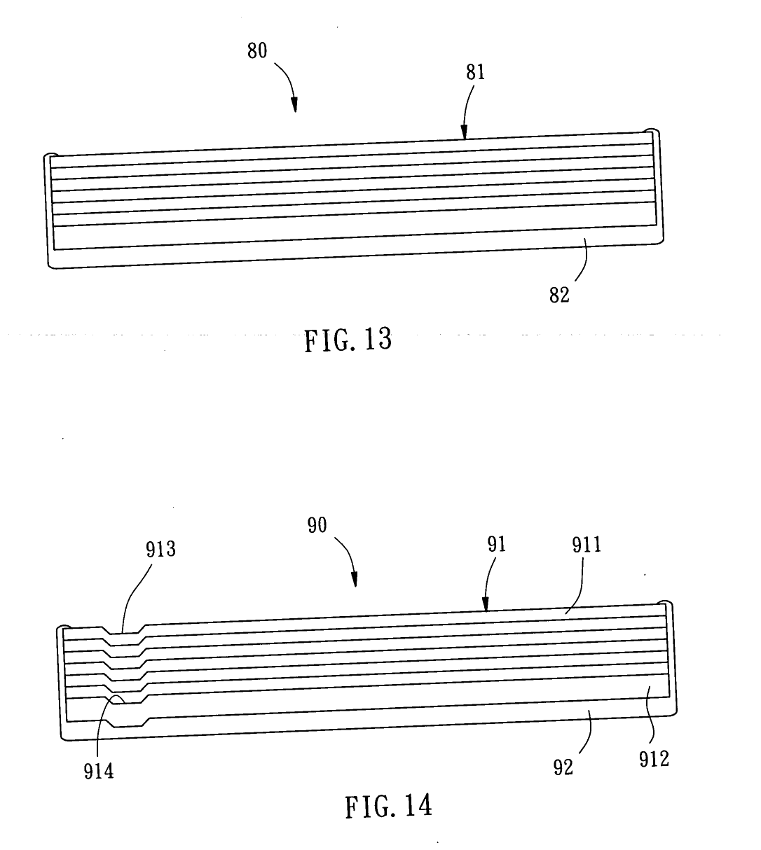

Referring to FIG. 13, the multi-layer chopping board 80 constructed according to an eighth preferred embodiment of the present invention is similar to the chopping board 70 of the seventh preferred embodiment, but different only by that the cover layer 82 formed at the bottom side the main body 81 has a larger thickness to prevent the chopping board 80 from inconvenient operation incurred by insufficient thickness after all of the regular planks are peeled off.

Referring to FIG. 14, the multi-layer chopping board 90 constructed according to a ninth preferred embodiment of the present invention is similar to the chopping board 80 of the second preferred embodiment, but different as recited below.

Each regular plank 911 further has a positioning portion 913, which is provided respectively with a concavity formed at a top side thereof and a convexity formed at its bottom side. The reinforced plank 912 also has a positioning portion 914 corresponding to the positioning portion 913. Accordingly, the regular and reinforced planks 911 and 912 can be well stacked upon another by that each concavity and each convexity fit each other.

In conclusion, the present invention includes two advantages as follows.

1. The cover layer is sheathed on the peripheral side of the main body to put together the regular and reinforced planks, and is less hard than the regular planks to be easily cut out, such that the top regular plank can be peeled off conveniently.

2. The main body is formed of the numerous regular planks and the reinforced plank, which is made of solid wood, metal, acrylics, or other alternative material having preferable inflexibility, such that the chopping board of the present invention is not subject to deformation to prevent inconvenience incurred by the deformation.

1. A multi-layer chopping board comprising:
a main body having a plurality of regular planks and a reinforced plank stacked upon another, said reinforced plank being made of a material more inflexible than that of said regular plank; and
a cover layer sheathed on a peripheral side of said main body and made of a material different from those of said planks.

2. The chopping board as defined in claim 1, wherein said reinforced plank is located between any two of said regular planks.

3. The chopping board as defined in claim 1, wherein said reinforced plank is located at a bottom side of said main body.

4. The chopping board as defined in claim 1, wherein said cover layer is less hard than said main body.

5. The chopping board as defined in claim 1, wherein said cover layer is further sheathed on a bottom side of said main body.

6. The chopping board as defined in claim 1, wherein said cover layer is further sheathed on peripheral edges of a top side and a bottom side of said main body.

7. The chopping board as defined in claim 1, wherein said cover layer further comprises a plurality of guiding portions, each of which corresponds in location to where between each two adjacent regular planks for facilitating a knife's cutting off said regular planks.

8. The chopping board as defined in claim 7, wherein said guiding portions are continuously recessed on said cover layer.

9. The chopping board as defined in claim 7, wherein said guiding portions are discontinuously recessed on said cover layer.

10. The chopping board as defined in claim 7, wherein said guiding portions are partially formed on said cover layer.

11. The chopping board as defined in claim 1, wherein the cover layer further comprises a plurality of stepped portions formed at a lateral side of said main body, each of said stepped portions having a guiding portion corresponding in location to where between each two adjacent regular planks.

12. The chopping board as defined in claim 1, wherein each of said planks is provided with the same design.

13. The chopping board as defined in claim 1, wherein said main body further comprises a slot running therethrough for the user's holding said chopping board.

14. The chopping board as defined in claim 1, wherein said main body further comprises a handle extending outwards from a lateral side thereof.

15. The chopping board as defined in claim 1, wherein said reinforced plank is made of a wood laminate.

16. The chopping board as defined in claim 1, wherein said reinforced plank is made of solid wood.

17. The chopping board as defined in claim 1, wherein said reinforced plank is made of acrylics.

18. The chopping board as defined in claim 1, wherein said reinforced plank is made of metallic material.
